(19) United States
(12) Patent Application Publication
(10) Pub. No.: US 2008/0085496 A1
(43) Pub. Date: Apr. 10, 2008

(54) Learning tool

(76) Inventor: John S. Hodge, Tallahassee, FL (US)

Correspondence Address: John Wiley Horton;Pennington, Moore, Wilkinson, Bell & Dunbar, P.A., 2nd Floor, 215 S. Monroe St., Tallahassee, FL, 32301, US

(21) Appl. No.: 11/542,800

(22) Filed: Oct. 4, 2006

(51) Int. Cl. G09B 17/00

(52) U.S. Cl. 434/178

(57) ABSTRACT

A learning tool for teaching a child how to read or for encouraging a child to practice his or her reading skills. The learning tool includes a container having a plurality of compartments. A message strip is provided in each of the compartments. Each message strip preferably contains a portion of a story or rhyme, so that when the messages are viewed in sequence, the child may read the story or rhyme from beginning to end. Each message strip is attached within the compartment at one end of the message strip. Each message strip is configured to be retrievable from the compartment, so that when the message strip is retrieved from the compartment the child can view the message contained on the strip.

### BACKGROUND OF THE INVENTION

1. Field of the Invention

This invention relates to the field of learning tools and educational toys. More specifically, this invention comprises a learning tool having compartments with message strips contained therein.

2. Description of the Related Art

Many learning tools and educational toys have been created for teaching children how to read. These tools and toys generally seek to maintain a child's attention for a significant period of time as the child learns to associate words and letter combinations with sounds and meanings. In order to accomplish this, effective learning tools are interactive and engaging. Interactivity is accomplished in various ways in the prior art. Some reading toys incorporate audio “playback” features which play an audio sample when a button is pressed or a page is turned. Other learning tools accomplish interactivity by incorporating “tactile” features such as raised images or objects that can be manipulated along with the text.

Although many learning tools are available, there is still a need for new learning tools and educational toys that will stimulate a child's senses while encouraging the child to read. Those that are skilled in the art know that children eventually lose interest in even the most interactive and engaging learning tools. Accordingly, it would be desirable to provide a new interactive learning tool for teaching a child to read.

### BRIEF SUMMARY OF THE INVENTION

The present invention is a learning tool for teaching a child how to read or for encouraging a child to practice his or her reading skills. The learning tool includes a container having a plurality of compartments. A message strip is provided in each of the compartments. Each message strip preferably contains a portion of a story, rhyme or other passage, so that when the messages are viewed in sequence, the child may read the passage from beginning to end. Each message strip is attached within the compartment at one end of the message strip. Each message strip is configured to be retrievable from the compartment, so that when the message strip is retrieved from the compartment the child can view the message contained on the strip.

In one embodiment, each message strip is folded and enclosed in the compartment by a lid. To retrieve the message, the lid is opened, and the message is pulled out of the compartment. The message may then be folded back into the compartment, and the lid may be closed.

In a second embodiment, each message strip is rolled onto a spring-biased drum. To retrieve the message, the message is pulled through a slot in the container. When released, the message is pulled back into the compartment through the slot by the force of the spring.

### BRIEF DESCRIPTION OF THE SEVERAL VIEWS OF THE DRAWINGS

FIG. 1 is a perspective view, showing the present invention.

FIG. 2 is a section view, showing the present invention.

FIG. 3 is a perspective view, showing the present invention.

FIG. 4 is a perspective view, showing the present invention.

FIG. 5 is a top view, showing the present invention.

### REFERENCE NUMERALS IN THE DRAWINGS

| | | | |
|---|---|---|---|
| 10 | learning tool | 12 | container |
| 14 | compartments | 16 | lids |
| 18 | strip | 20 | tab |
| 22 | side wall | 24 | side wall |
| 26 | bottom | 28 | attached end |
| 30 | container | 32 | compartments |
| 34 | strip | 36 | fixed rod |
| 38 | drum | 40 | slot |
| 42 | pull handle | 44 | flat spring |
| 46 | text | 48 | images |

### DETAILED DESCRIPTION OF THE INVENTION

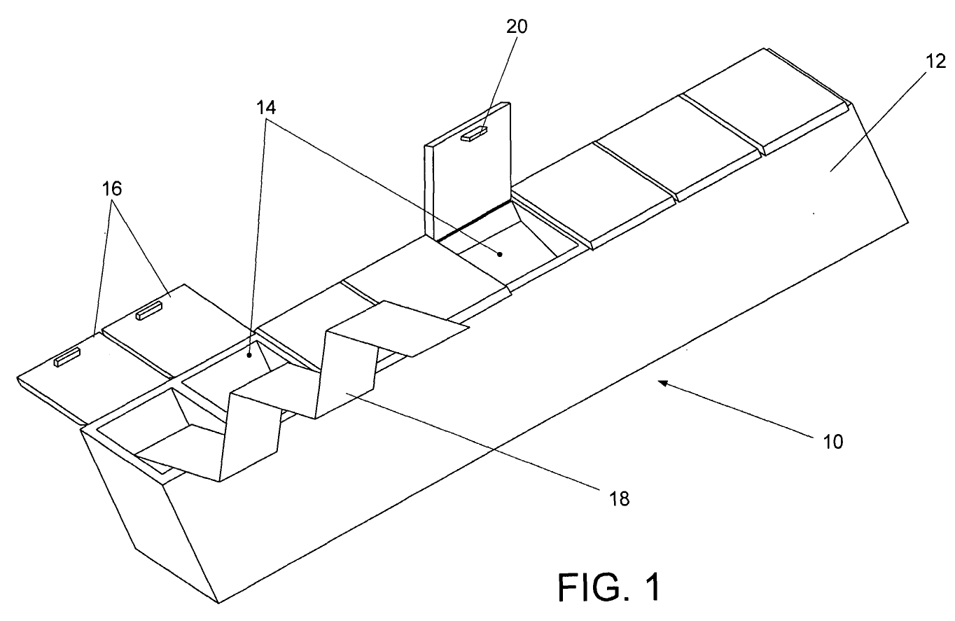

The present invention, learning tool 10, is illustrated in FIG. 1. Learning tool 10 is an educational toy which may be used in teaching a child how to read or for encouraging a child to practice his or her reading skills. Learning tool 10 includes container 12 which has a plurality of compartments 14. Container 12 is preferably small enough to be comfortably held in a child's hand. Although eight compartments are illustrated in FIG. 1, any number of compartments 14 may be used.

A single strip 18 is provided in each compartment 14. Each strip 18 contains some message that is printed or otherwise affixed thereto. Strip 18 may be a piece of laminated paper, cloth, or some other durable material. The message contained on strip 18 may be text, images, or combinations thereof. In the preferred embodiment, each strip 18 contains a portion of a story, rhyme or other passage, so that when the messages are viewed in sequence, the child may read the passage from beginning to end.

Each strip 18 is normally contained and enclosed within compartment 14. Lids 16 are provided for each compartment 14. Each lid 16 includes a tab 20 which engages a side wall of compartment 14 when lid 16 is closed. This helps contain strips 18 within compartments 14 until the user elects to view the message. To view the messages, the user simply pushes up on the exposed edge of lid 16 causing tab 20 to disengage with the side wall. The user may then grab one end of strip 18 and pull strip 18 substantially out of compartment 14. Strip 18 is attached within compartment 14, so that a portion of strip 18 is always retained within compartment 14. When finished viewing the message, the user may stuff strip 18 back into compartment 14 and close lid 16.

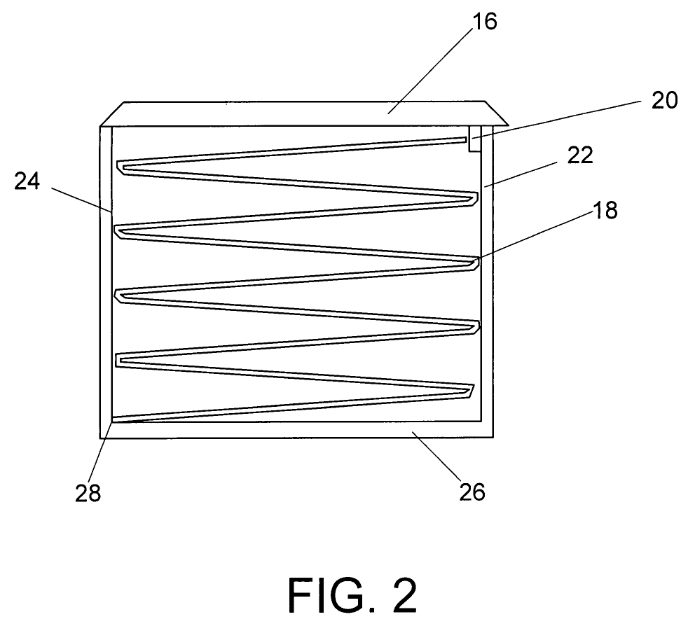

FIG. 2 is a section view of compartment 14, showing lid 16 in the closed position. In the closed position, tab 20 mates with the surface of side wall 22, thereby retaining lid 16 in place. In the current embodiment, frictional engagement between tab 20 and side wall 22 hold the components together. Those that are skilled in the art know that interlocking features may be provided on the components to hold the components together. A flexible joint or hinge is provided on the side of lid 16 opposite of tab 20 (adjacent to side wall 24). This allows lid 16 to be moved back and forth between an open position and a closed position. Attached end 28 of strip 18 is attached to bottom 26 by an epoxy or glue. Rivets, brads, staples, or other types of fasteners may similarly be used. This feature prevents strip 18 from completely separating from its compartment. Alternatively, detachable fasteners such as VELCRO or snaps may be used to attach the strips to the compartment. This would allow the strips to be replaced or rearranged if desired. As illustrated in FIG. 2, strip 18 is folded into the compartment when lid 16 is closed.

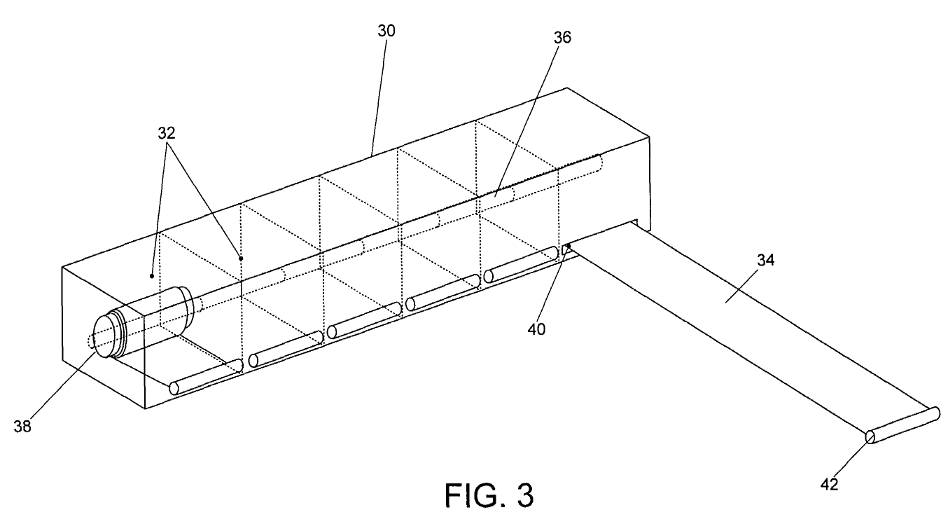

An alternate embodiment of the present invention is illustrated in FIG. 3. The alternate embodiment utilizes a spring-biased drum to hold the message strips in container 30 until the user pulls the message strips out of compartments 32. Fixed rod 36 extends through compartments 32 from one end of container 30 to the other. Strip 34 is wrapped around drum 38 so that strip 34 may be rolled (as shown in the compartment closest to the viewer of FIG. 3) and unrolled (as shown in the compartment farthest from the viewer in FIG. 3). Although not illustrated in FIG. 3, the reader will note that each compartment 32 has a separate drum 30 over which strip 34 is wrapped. One end of strip 34 extends through slot 40 provided in compartment 32. This end of strip 34 attaches to pull handle 42. Pull handle 42 is preferably larger than slot 40 to prevent strip 34 from being pulled completely within compartment 32. Pull handle 42 also provides a gripping feature for pulling out strip 34 when viewing the messages contained thereon.

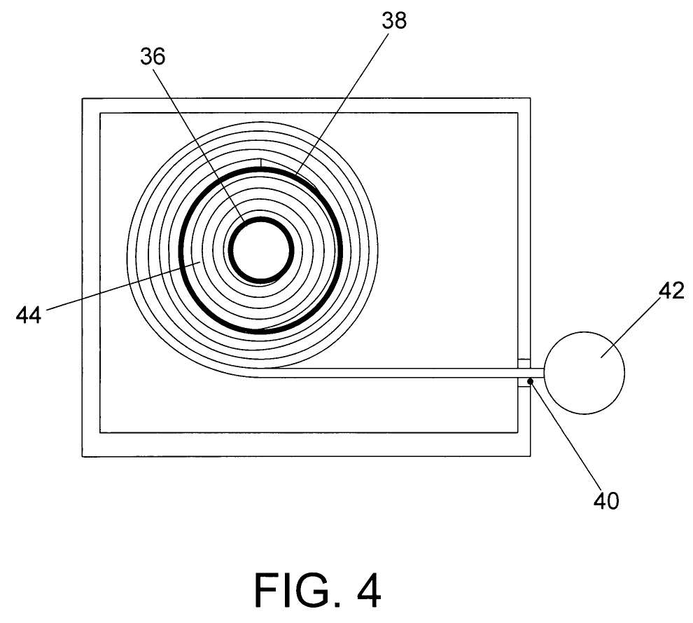

Turning to FIG. 4, flat spring 44 is provided between drum 38 and fixed rod 36. Flat spring 44 may be a bimetallic constant force spring. This allows drum 38 to rotate about fixed rod 36 while fixed rod 36 remains stationary. Flat spring 44 exerts a force on drum 38 which tends to pull strip 34 into compartment 32. In the version illustrated in FIG. 4, flat spring 44 torques drum 38 in a clockwise direction. When the user pulls pull handle 42, the user must pull with enough force to overcome the force of flat spring 44, causing drum 38 to rotate in the counterclockwise direction. When the user releases pull handle 42, the force of flat spring 44 draws strip 34 back into compartment 32.

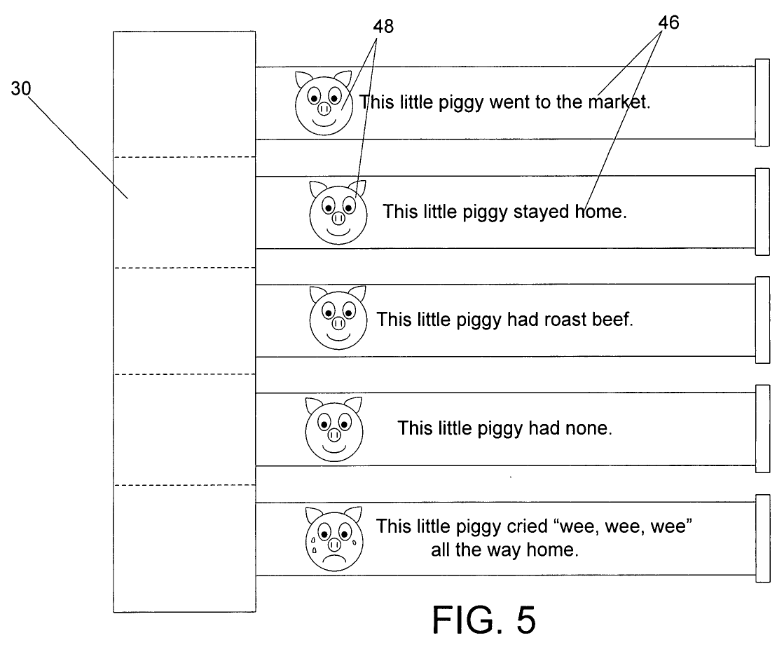

FIG. 5 illustrates the present invention with the message strips substantially removed from the compartments. If the user pulls the message strips out of container 30 in sequence (starting with the top message strip), the user would read the familiar “This Little Piggy” nursery rhyme from beginning to end. Each strip contains text 46 and images 48. Accordingly, when viewing adjacent compartments 32, the viewer may read the passage in sequence. Obviously, longer passages of text or more sophisticated illustrations can be incorporated onto the message strips. Those that are skilled in the art will realize that an entire children's story may be easily integrated into learning tool 10.

The preceding description contains significant detail regarding the novel aspects of the present invention. It should not be construed, however, as limiting the scope of the invention but rather as providing illustrations of the preferred embodiments of the invention. As an example, various mechanisms may be provided for storing the message strips in the compartment or retrieving the message strips therefrom. Such a variation would not alter the function of the invention. Thus, the scope of the invention should be fixed by the following claims, rather than by the examples given.

Having described my invention, I claim:

1. A learning tool for a child, comprising:
a. a container, said container having a plurality of compartments;
b. a plurality of message strips, each of said plurality of message strips contained in one of said plurality of compartments; each of said plurality of message strips having a first end, a second end, and a message provided thereon between said first end and said second end;
c. wherein each of said plurality of message strips is attached within said compartment proximal said first end; and
d. wherein each of said message strips is configured to be retrievable from said compartment such that said child can view said message contained thereon.

2. The learning tool of claim 1, wherein each of said plurality of message strips is folded within said compartment.

3. The learning tool of claim 1, wherein said container further comprises a plurality of lids, each of said plurality of lids movable between an open position and a closed position, each of said plurality of lids configured to enclose one of said plurality of message strips within said compartment when said lid is in said closed position.

4. The learning tool of claim 1, wherein each of said plurality of message strips contains a portion of a passage, such that when said plurality of message strips are viewed in sequence, said passage may be read from beginning to end.

5. The learning tool of claim 1, wherein each of said plurality of message strips are attached to a spring-biased drum, said spring-biased drum configured to retain said message strip substantially within said compartment until said child pulls said message strip out of said compartment.

6. The learning tool of claim 5, each of said plurality of compartments further comprising a slot, and wherein said second end of message strip projects through said slot out of said compartment.

7. The learning tool of claim 4, wherein each of said plurality of message strips is folded within said compartment.

8. The learning tool of claim 4, wherein said container further comprises a plurality of lids, each of said plurality of lids movable between an open position and a closed position, each of said plurality of lids configured to enclose one of said plurality of message strips within said compartment when said lid is in said closed position.

9. The learning tool of claim 4, wherein each of said plurality of message strips are attached to a spring-biased drum, said spring-biased drum configured to retain said message strip substantially within said compartment until said child pulls said message strip out of said compartment.

10. The learning tool of claim 9, each of said plurality of compartments further comprising a slot, and wherein said second end of message strip projects through said slot out of said compartment.

11. A learning tool for a child, comprising:
a. a container, said container having a first compartment and a second compartment;
b. a first message strip, having a first end, a second end, and a middle portion therebetween;
c. a second message strip, having a first end, a second end, and a middle portion therebetween;
d. wherein said first end of said first message strip is attached within said first compartment, and said first message strip is configured to be movable between a first position wherein said first message strip is substantially contained within said first compartment and a second position wherein said first message strip is substantially removed from said first compartment thereby permitting said child to view said first message strip; and
e. wherein said first end of said second message strip is attached within said second compartment, and said second message strip is configured to be movable between a first position wherein said second message strip is substantially contained within said second compartment and a second position wherein said second message strip is substantially removed from said second compartment thereby permitting said child to view said second message strip.

12. The learning tool of claim 11, wherein each of said first message strip is folded within said first compartment and said second message strip is folded within said second compartment.

13. The learning tool of claim 11, wherein said container further comprises a first lid and a second lid, said first and second lids movable between an open position and a closed position, said first lid configured to enclose said first message strip in said first compartment when said first lid is in said closed position, and said second lid configured to enclose said second message strip in said second compartment when said second lid is in said closed position.

14. The learning tool of claim 11, wherein said first message strip contains a first portion of a passage and said second message strip contains a second portion of said passage, such that when said first and second message strips are viewed in sequence, said passage may be read in sequence.

15. The learning tool of claim 11, wherein said first message strip is attached to a spring-biased drum, said spring-biased drum configured to retain said first message strip substantially within said first compartment until said child pulls said first message strip out of said first compartment.

16. The learning tool of claim 15, said first compartment further comprising a slot, and wherein said second end of first message strip projects through said slot out of said first compartment.

17. The learning tool of claim 14, wherein each of said first message strip is folded within said first compartment and said second message strip is folded within said second compartment.

18. The learning tool of claim 14, wherein said container further comprises a first lid and a second lid, said first and second lids movable between an open position and a closed position, said first lid configured to enclose said first message strip in said first compartment when said first lid is in said closed position, and said second lid configured to enclose said second message strip in said second compartment when said second lid is in said closed position.

19. The learning tool of claim 14, wherein said first message strip is attached to a spring-biased drum, said spring-biased drum configured to retain said first message strip substantially within said first compartment until said child pulls said first message strip out of said first compartment.

20. The learning tool of claim 19, said first compartment further comprising a slot, and wherein said second end of first message strip projects through said slot out of said first compartment.
